(19) United States
(12) Patent Application Publication
(10) Pub. No.: US 2020/0305391 A1
(43) Pub. Date: Oct. 1, 2020

(54) Dog Protective Garment

(71) Applicant: Abigail Ann Davis, Edin, MN (US)

(72) Inventor: Abigail Ann Davis, Edin, MN (US)

(21) Appl. No.: 16/826,527

(22) Filed: Mar. 23, 2020

Related U.S. Application Data
(60) Provisional application No. 62/827,541, filed on Apr. 1, 2019.

(51) Int. Cl. A01K 13/00

(52) U.S. Cl. CPC A01K 13/006

(57) ABSTRACT

A protective garment for dogs includes a fabric pouch configured to form a pocket having an opening on one side. A fabric flap is attached to the open side of the pouch and extends away from the pouch, and a body strap is coupled to the flap opposite from where the flap is attached to the pouch and is configured to be fastened around the torso of dog. First and second leg straps are coupled to the open side of the pouch opposite where the flap is attached to the pouch and to the body strap, and are configured to be positioned around the legs or hips of a dog.

### FIELD

The invention relates generally to garments for dogs, and more particularly to a dog protective garment.

### BACKGROUND

Domestic dogs are widely believed to be descendants of the extinct gray wolf, and the first species of animal to be domesticated. Early dogs were domesticated ten thousand years ago or more, likely as a result of cooperation between humans and the earliest domestic dogs, with each benefiting from the other's unique hunting abilities as well as from companionship. Over time, domesticated dogs were selectively bred to have characteristics desirable to humans, including being less aggressive and less likely to kill within their own social groups. Similarly, natural selection is believed to have played a role in domestic dogs' ability to understand human gestures and commands, improving the dogs' skill at communication and cooperation with both humans and other dogs.

These processes also resulted in what is sometimes referred to as “domestication syndrome,” in which the dogs developed smaller heads and smaller teeth, floppy ears, and other physical characteristics unsuitable for a wild carnivore but tolerated or encouraged in a domestic animal. Selective breeding to produce desirable characteristics such as a more moderate adrenaline pathway produced dogs that are tamer and more emotionally responsive than the fight-or-flight reactionary wolves from which they descended, but the reduced aggression also had the unintended side effect of reduced fear among domestic dogs, resulting in domestic dogs that frequently appear to overestimate their abilities in challenging other animals.

Domestic dogs were eventually bred into a variety of distinct breeds suitable for different purposes, such as hunting, herding, and other working tasks, and “toy” or other companion dogs bred solely for their companionship qualities. Modern breeds of domestic dogs include many breeds that would likely be unsuccessful as wild animal species, but that have various characteristics such as facial appearance, size, coat length, leg length, coloring, intelligence, and other such characteristics that make them attractive to particular groups of dog owners and breeders.

Some breeds such as pugs and bulldogs have been bred to have characteristics that are now causing criticism of some traditional breeding methods, as the flattened face that characterizes these dog breeds results in breathing problems resulting from narrowed nostrils and windpipe, as well as a host of eye issues from eyes that protrude unusually far from the dogs' faces. Other breeds have more minor but distinct characteristic issues, such as short-haired dogs that are no longer protected from cold and from other environmental hazards such as long grasses and branches as well as their ancestors.

In one specific example, German shorthaired pointer dogs have shorter hair than many other dogs, despite being descendants of pointers traditionally used as hunting dogs to indicate or point out prey for human companions. The short hair may be a desirable trait in a companion animal to reduce the amount of hair shed in a shared living environment or to reduce brushing or other maintenance of a longer coat, but it reduces the dog's protection from environmental hazards such as cold weather and brush.

A need therefore exists for compensating for some such characteristics bred into some dogs, such as purebred dogs that have been bred to differ substantially from their ancestors.

### SUMMARY

One example embodiment of the invention comprises a protective garment for dogs, including a fabric pouch configured to form a pocket having an opening on one side. A fabric flap is attached to the open side of the pouch and extends away from the pouch, and a body strap is coupled to the flap opposite from where the flap is attached to the pouch and is configured to be fastened around the torso of dog. First and second leg straps are coupled to the open side of the pouch opposite where the flap is attached to the pouch and to the body strap, and are configured to be positioned around the legs or hips of a dog.

In another embodiment, the pouch comprises two pieces of fabric affixed to each other on three sides to form the pocket, or comprises a single piece of fabric folded over and attached on its sides to form the pocket.

In a further embodiment, the flap comprises the folded over piece of fabric extending beyond the pocket opening, and is is configured to position the flap strap in front of a dog's rear legs.

The details of one or more examples of the invention are set forth in the accompanying drawings and the description below. Other features and advantages will be apparent from the description and drawings, and from the claims.

### BRIEF DESCRIPTION OF THE FIGURES

FIG. 1 shows fabric used to make a pouch and flap portion of a dog protective garment, consistent with an example embodiment, consistent with an example embodiment.

FIG. 2 shows the fabric of FIG. 1 folded to form a pouch and flap portion of a dog protective garment, consistent with an example embodiment, consistent with an example embodiment.

FIG. 3 shows attachment of first and second leg straps to the protective garment, consistent with an example embodiment, consistent with an example embodiment.

FIG. 4 shows a body strap attached to the protective garment, consistent with an example embodiment, consistent with an example embodiment.

FIG. 5 shows the protective garment of FIG. 4 with the body strap ends detached from one another, consistent with an example embodiment, consistent with an example embodiment.

FIG. 6 shows a protective dog garment worn by a dog from the underside of the dog's torso, consistent with an example embodiment.

FIG. 7 shows a protective dog garment worn by a dog from the side of the dog's rear torso, consistent with an example embodiment.

FIG. 8 shows a protective dog garment worn by a dog from above the rear of the dog's torso, consistent with an example embodiment.

FIG. 9 shows a protective dog garment worn by a dog from the side of the dog's rear torso, consistent with an example embodiment.

### DETAILED DESCRIPTION

In the following detailed description of example embodiments, reference is made to specific example embodiments by way of drawings and illustrations. These examples are described in sufficient detail to enable those skilled in the art to practice what is described, and serve to illustrate how elements of these examples may be applied to various purposes or embodiments. Other embodiments exist, and logical, mechanical, electrical, and other changes may be made.

Features or limitations of various embodiments described herein, however important to the example embodiments in which they are incorporated, do not limit other embodiments, and any reference to the elements, operation, and application of the examples serve only to define these example embodiments. Features or elements shown in various examples described herein can be combined in ways other than shown in the examples, and any such combinations is explicitly contemplated to be within the scope of the examples presented here. The following detailed description does not, therefore, limit the scope of what is claimed.

Dog breeding has resulted in significant changes in various breeds from the gray wolf (now extinct) believed to be the common ancestor to modern dogs, with many such characteristics benefiting the dog's ability to live with humans or to perform certain tasks such as herding or hunting. But, other characteristics such as a flat face or very short hair that are desired by dog owners or characteristic of certain recognized dog breeds may not benefit the dog, and in some cases may result in medical or other problems.

More particularly, German shorthaired pointers and certain other dogs have substantially shorter hair than the wolves from which they descended, and have developed some compensations over time such as a two-layered coat comprising a dense undercoat protected by relatively stiffer guard hairs. Still, the two-layered coat of hair does not protect areas of the dog (such as the belly where even a shorthair dog's coat is relatively short) as well as the longer coat typical of wolves and some other dog breeds, especially in extreme weather conditions or when exposed to brush or stiff grasses. This problem can be exacerbated where an un-neutered male dog's testicles hang down exposed, as the greater surface area can result in rapid frostbite in cold temperatures and the relatively lower position relative to the dog's belly can result in significant abrasion in tall brush. Some embodiments described herein therefore provide a protective garment for dogs, shielding the exposed testicles from cold weather, abrasion, and other such risks.

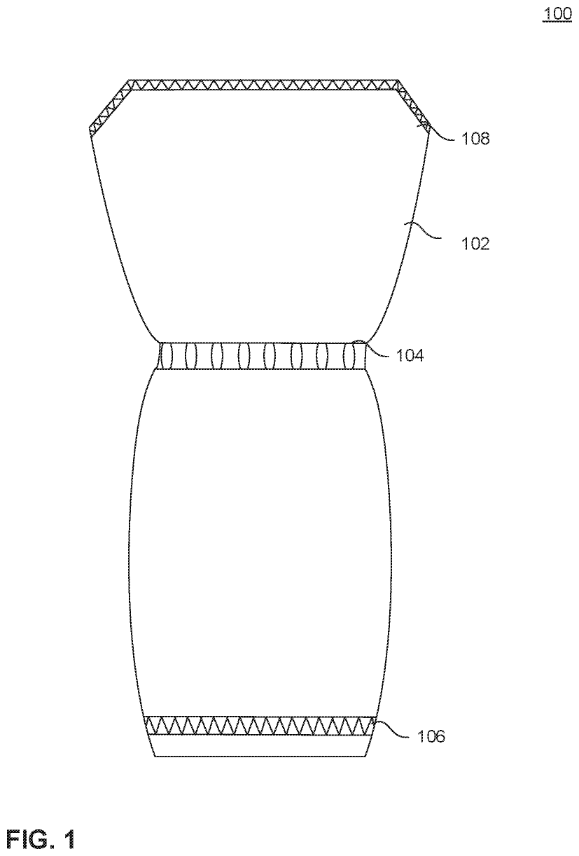

FIG. 1 shows fabric used to make a pouch and flap portion of a dog protective garment, consistent with an example embodiment. As shown generally at 100, a piece of fabric 102 is cut to shape and elastic is sewn at points 104 and 106, which will eventually form the opening of the pocket or pouch portion of the garment. Other edges of the fabric that will not be sewn are in this example further protected, such as by overstitching or serging the edge as shown at 108. The fabric in this example is a polar fleece material designed to provide thermal insulation and selected for softness and easy laundering, but in other examples is another insulating material, or a material designed to provide other characteristics such as a nylon fabric designed to prevent abrasion.

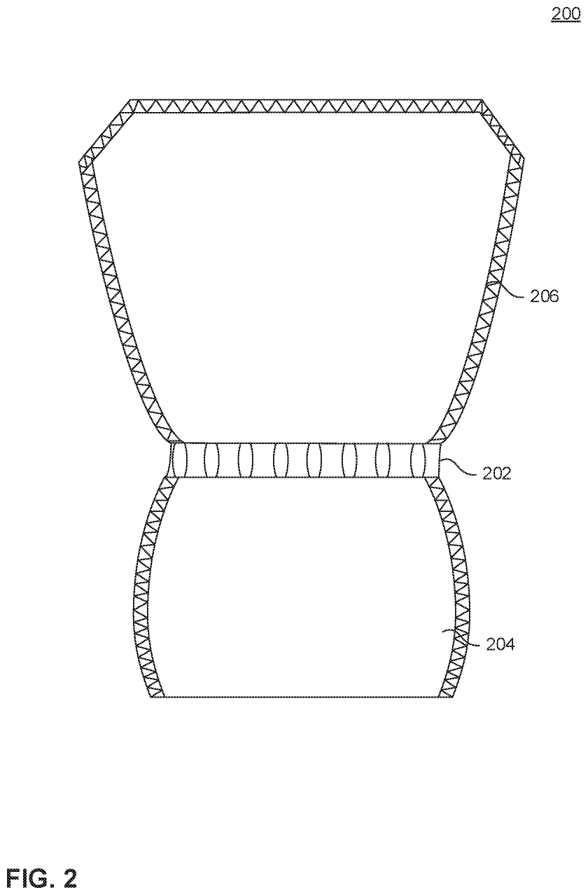

FIG. 2 shows the fabric of FIG. 1 folded to form a pouch and flap portion of a dog protective garment, consistent with an example embodiment. As shown generally at 200, the fabric has been folded over from its configuration in FIG. 1, bringing the elastic portions 104 and 106 of FIG. 1 together at 202 to form a pouch portion 204. The edges of the fabric are sewn together to secure the sides of the pouch, making the area in which the elastic portions 104 and 106 meet the only opening in the pouch. The remainder of the fabric not a part of the pouch or pocket forms a flap as shown at 206. The edges in this example are similarly finished with a serger, protecting the fabric from fraying and enhancing the longevity of the protective garment.

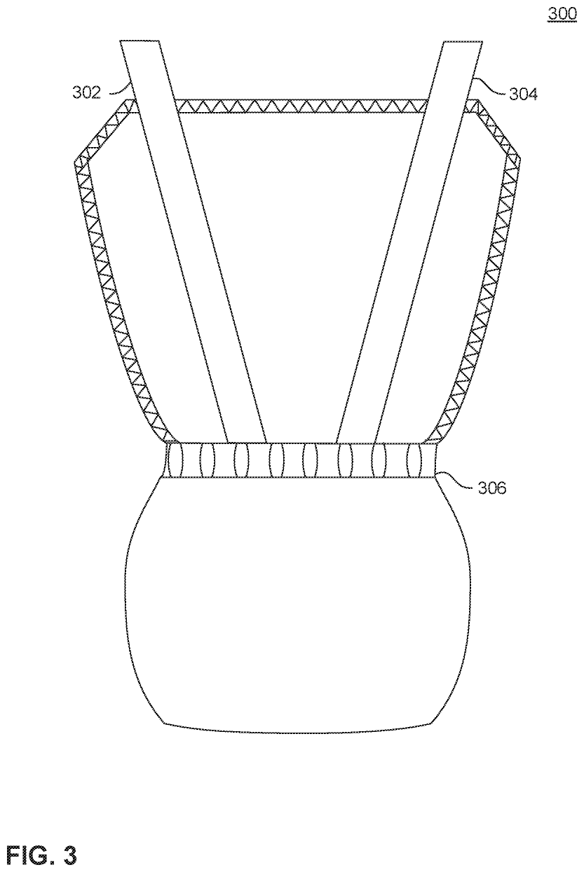

FIG. 3 shows attachment of first and second leg straps to the protective garment, consistent with an example embodiment. As shown generally at 300, first leg strap 302 and second leg strap 304 are attached to the pouch portion of the fabric, opposite the side of the opening where the flap is attached to the pouch. This is shown at 306 as approximately half the pouch opening circumference being attached to the flap portion of the pouch and the other half of the pouch opening circumference supporting attachment of the first and second leg straps 302 and 304.

In this example, the first and second leg straps are elastic, and designed to stretch around the legs or hips of a dog when worn. In a further example, the protective garment is available in multiple sizes, each having different first and second elastic strap lengths. In an alternate embodiment, the first and second leg straps are adjustable, such as with a buckle that can be adjusted to various positions along at least a portion of the straps, with Velcro that can be attached at various positions along a continuous strip, or with another such mechanism.

The first leg strap 302 and the second leg strap 304 are in this example positioned within an inch of one another, measured nearest edge to nearest edge, to prevent leaving a large space along the middle of the pocket opening unsupported by a leg strap. In use, this helps prevent a dog's testicles from escaping the pocket, such as by falling out in a gap between the leg straps. In other examples, the gap between the leg straps where affixed to the pouch is 0.25 inches, 0.5 inches, 0.75 inches, 1.25 inches, 1.5 inches, or another suitable distance.

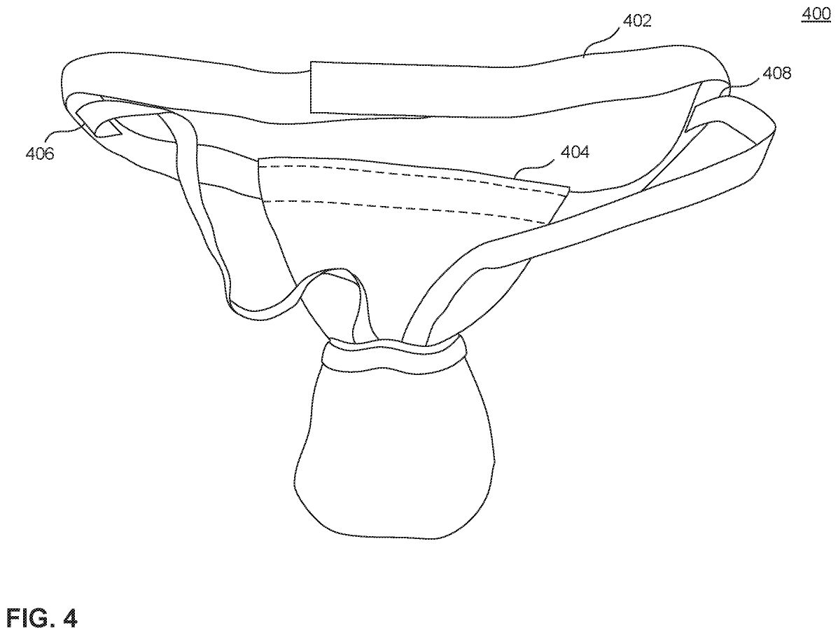

FIG. 4 shows a body strap attached to the protective garment, consistent with an example embodiment. Here, the protective garment as shown generally at 400 includes a body strap 402, which is configured to be affixed around the torso of a dog when in use. The strap in this example is a non-elastic nylon woven webbed strap, but in other embodiments comprises elastic or other materials.

The strap 402 is attached to the fabric flap of the protective garment at the side of the flap opposite where the pouch attaches to the flap, as shown at 404. Although it is attached here by sewing along the length of the flap, attachment of the body strap to the flap and/or various other elements of the protective garment will in other examples be achieved by glue, ultrasonic welding, rivets or snaps, or other such suitable means.

The ends of strap 402 attach to one another in this example by Velcro strips sewn onto each end of the strap, allowing some adjustment for size based on the length of the Velcro strips on each end of the strap. In a further example, different sizes of protective garments will have different ranges of adjustability for the circumference of the affixed or fastened body strap.

The ends of the first and second leg straps 302 and 304 of FIG. 3 opposite the leg strap ends attached to the pouch are further attached to the body strap. The first leg strap is attached to the body strap as shown at 406, and the second leg strap is attached to the body strap as shown at 408. As shown here, the leg straps are attached to different ends of the body strap, or on different sides of the area in which the body strap is attached to the flap as shown at 404. The distance between the area in which the body strap is attached to the flap as shown at 404 and the point along the body strap at which the leg straps are attached is in various examples 1 inch, 2 inches, 3 inches, 4 inches, 5 inches, 6 inches, 7 inches, 8 inches, 10 inches, 12 inches, or another suitable distance based on the physiology of the dog for which the protective garment is intended.

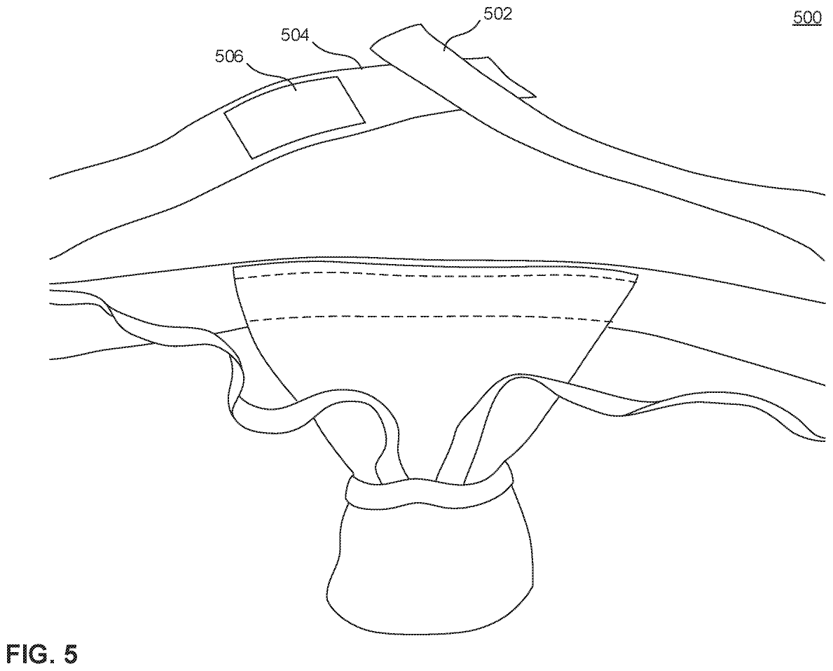

FIG. 5 shows the protective garment of FIG. 4 with the body strap ends detached from one another, consistent with an example embodiment. As shown generally at 500, the protective garment of FIG. 4 is shown with the body strap ends 502 and 504 detached to show two distinct ends of the strap. FIG. 5 also shows where Velcro 506 is attached to end 504 of the body strap, configured to removably attach to complementary Velcro affixed to the underside of body strap end 502.

In operation, the loops formed by the two leg straps, the pouch, and the body strap are placed around the rear legs of a dog and the protective garment is raised up to the dog's torso, configured such that the body strap is positioned toward the front of the dog's torso and the region of the pouch where the leg straps attach is positioned toward the rear end of the dog's torso. The pouch or pocket is then adjusted to capture or contain the dog's testicles, and the body strap is wrapped around the dog's torso and the ends of the body strap are affixed to one another such as by Velcro, a buckle, a snap, or another suitable means.

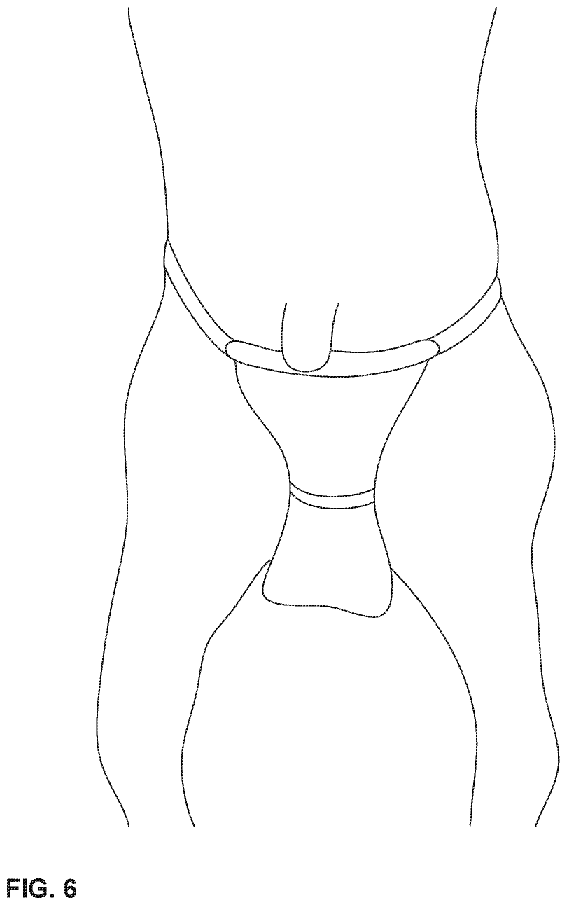

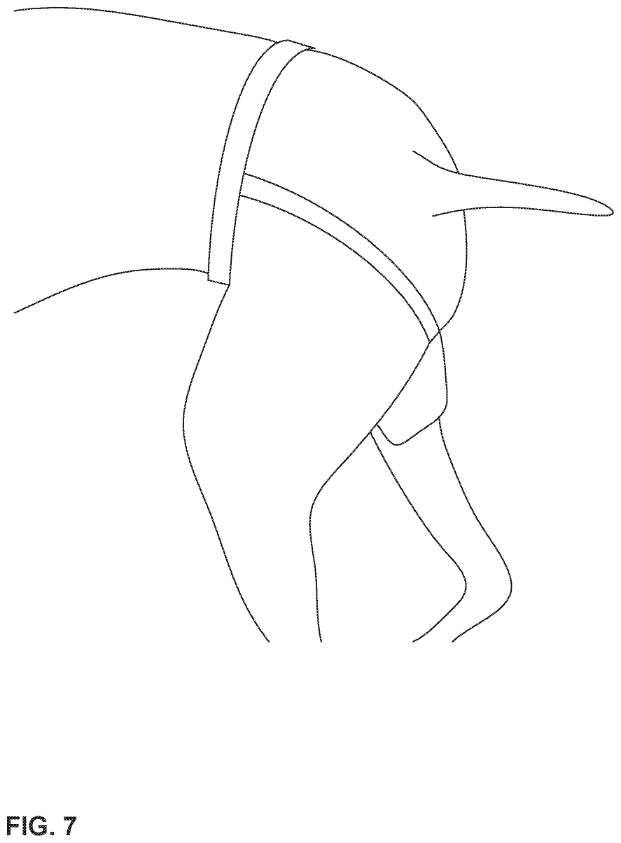

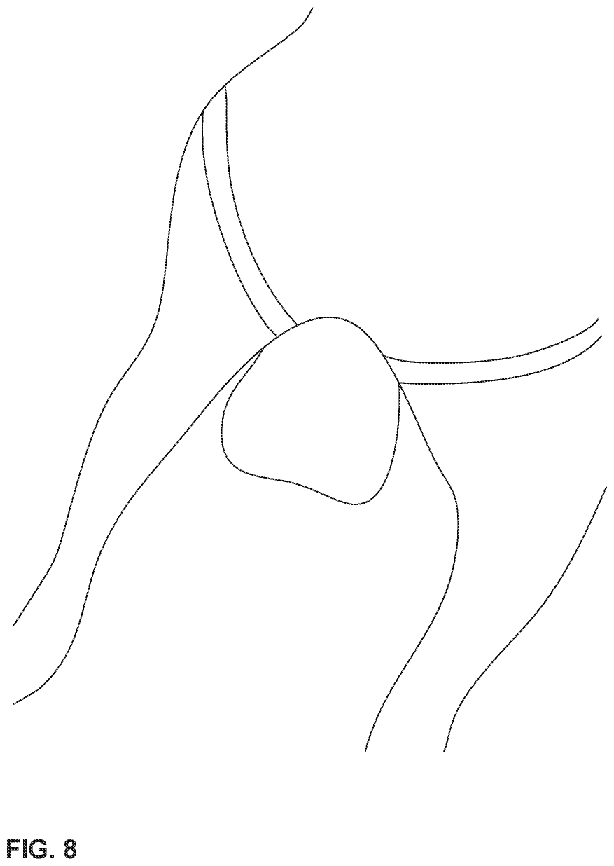

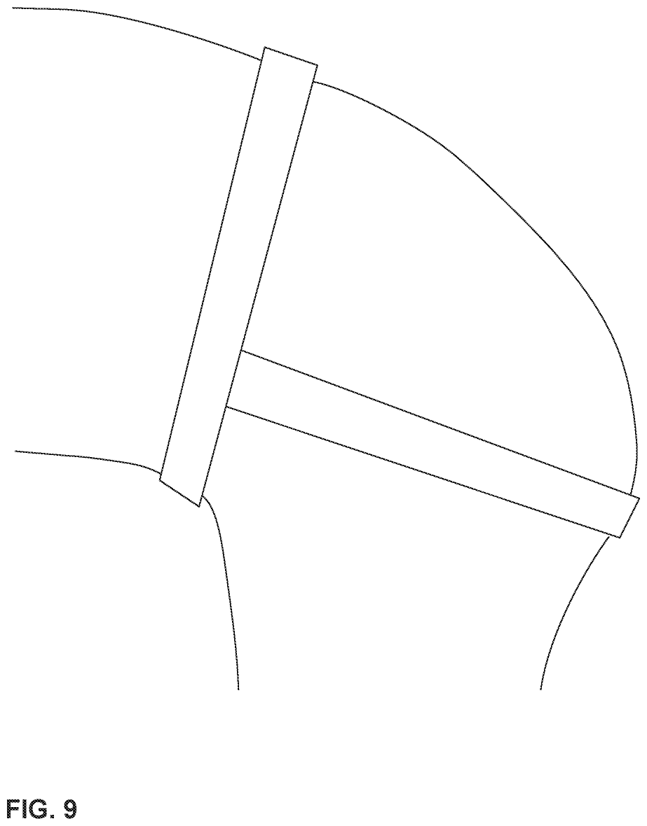

The protective garment of FIGS. 4 and 5 is shown on a dog in FIGS. 6-9, which illustrate how the protective garment protects the dog's testicles while leaving him free to urinate or defecate, such as when being let outside to relieve himself during cold winter months or when taken for a walk. In the examples shown, the body strap is worn just in front of the dog's hips and allows freedom of urination. The elastic leg straps attached to the pouch or pocket run across the dog's flank when worn, staying out of the way for stooling. More particularly, FIG. 6 shows a protective dog garment worn by a dog from the underside of the dog's torso, consistent with an example embodiment. FIG. 7 shows a protective dog garment worn by a dog from the side of the dog's rear torso, consistent with an example embodiment. FIG. 8 shows a protective dog garment worn by a dog from above the rear of the dog's torso, consistent with an example embodiment. FIG. 9 shows a protective dog garment worn by a dog from the side of the dog's rear torso, consistent with an example embodiment.

These examples illustrate how a protective garment for dogs can be made and used to prevent frostbite, abrasion, or other trauma to a dog's testicles. Although specific embodiments have been illustrated and described herein, any arrangement that achieve the same purpose, structure, or function may be substituted for the specific embodiments shown. This application is intended to cover any adaptations or variations of the example embodiments of the invention described herein. These and other embodiments are within the scope of the following claims and their equivalents.

1. A protective garment for dogs, comprising:
a pouch comprising fabric configured to form a pocket having an opening on one side;
a flap comprising fabric attached to the open side of the pouch and extending away from the pouch;
a body strap coupled to the flap opposite from where the flap is attached to the pouch, the body strap configured to be fastened around the torso of dog;
first and second leg straps, each of the first and second leg straps coupled to the open side of the pouch opposite where the flap is attached to the pouch and to the body strap, the first and second leg straps configured to be positioned around the legs or hips of a dog.

2. The protective garment for dogs of claim 1, wherein the pouch comprises two pieces of fabric affixed to each other on three sides to form the pocket.

3. The protective garment for dogs of claim 1, wherein the pouch comprises a single piece of fabric folded over and attached on its sides to form the pocket.

4. The protective garment for dogs of claim 3, wherein the flap comprises the folded over piece of fabric extending beyond the pocket opening.

5. The protective garment for dogs of claim 1, wherein the flap is configured to position the flap strap in front of a dog's rear legs.

6. The protective garment for dogs of claim 1, wherein the ends of the body strap comprise an attachment mechanism enabling the ends to be attached to one another.

7. The protective garment for dogs of claim 6, wherein the attachment mechanism comprises at least one of Velcro, a snap, a clasp, and a buckle.

8. The protective garment for dogs of claim 6, wherein the body strap length when attached is adjustable.

9. The protective garment for dogs of claim 1, wherein the first and second leg straps comprise an elastic material.

10. The protective garment for dogs of claim 1, wherein the first and second leg straps are configured to be within an inch of one another where they are attached to the open side of the pouch.

11. The protective garment for dogs of claim 1, wherein the first and second leg straps are configured to prevent a dog's testicles from coming out of the pouch during dog activity.

12. The protective garment for dogs of claim 1, further comprising elastic affixed to at least a portion of the pocket's opening.

13. The protective garment for dogs of claim 1, wherein the garment is configured to cover a dog's testicles while not inhibiting urination or defecation.

14. The protective garment for dogs of claim 1, wherein the fabric comprises an insulating fabric.

15. The protective garment for dogs of claim 1, wherein the fabric is polar fleece-type material.

16. The protective garment for dogs of claim 1, wherein the fabric comprises an abrasion-resistant material.

17. The protective garment for dogs of claim 1, wherein the fabric comprises a woven fabric.

18. The protective garment for dogs of claim 1, wherein the body strap comprises a woven fabric.
